(19) United States
(12) Patent Application Publication
(10) Pub. No.: US 2012/0324344 A1
(43) Pub. Date: Dec. 20, 2012

(54) DISPLAY APPARATUS, DISPLAY METHOD, AND STORAGE MEDIUM

(75) Inventor: Masakatsu Sakurai, Toride-shi (JP)

(73) Assignee: CANON KABUSHIKI KAISHA, Tokyo (JP)

(21) Appl. No.: 13/493,801

(22) Filed: Jun. 11, 2012

(30) Foreign Application Priority Data
Jun. 14, 2011 (JP) 2011-132496

(51) Int. Cl. G06F 17/00

(52) U.S. Cl. 715/251

(57) ABSTRACT

A display apparatus includes a designation unit configured to designate a number of pages, a calculation unit configured to calculate an enlargement ratio based on original data, the number of pages designated by the designation unit, and an area of a display unit, a size change unit configured to change a size of an object included in the original data based on the enlargement ratio calculated by the calculation unit, and a display unit configured to display the object whose size has been changed by the size change unit on the display unit on a page-by-page basis by using the number of pages designated by the designation unit.

### BACKGROUND OF THE INVENTION

1. Field of the Invention

The present invention relates to a display apparatus, a display method, and a storage medium.

2. Description of the Related Art

According to improvements in the performance of portable information terminals (personal digital assistants (PDAs)), opportunities for reading Portable Document Format (PDF) documents and Word documents, whose layout is optimized for printing on paper, by the PDAs are increasing. However, since the screen of a PDA is small, when such documents are displayed on the PDA, the size of the characters is reduced according to the size of the screen. Accordingly, it is very difficult to read such characters. Thus, when a user reads an entire page of a document optimized for printing on paper by a PDA, the user enlarges the document on the display and scrolls the page in the vertical and horizontal directions.

On the contrary, if a document, whose layout is optimized for display of a PDA, is displayed on a large screen or printed on paper, the character may be too large to read and will be a waste of paper. Thus, multiple-up printing, which can make effective use of paper, is being performed.

Further, a layout adjustment technique that contributes to improving readability when a document is displayed at a size smaller than the original size is being proposed. Such a technique is discussed, for example, in Japanese Patent Application Laid-Open No. 2002-219837.

According to the technique discussed in Japanese Patent Application Laid-Open No. 2002-219837, a limit value of the character size is stored when multiple-up printing is performed. If the reduced character size is smaller than the limit value, based on character attributes such as character size, character pitch, and line break width of the input character data, the character size, character pitch, and line break width of the output character data are reconfigured. In this manner, readability is improved.

However, according to the technique discussed in Japanese Patent Application Laid-Open No. 2002-219837, when multiple-up printing is performed, a character which is too small is enlarged by narrowing the line space in the page and increasing the line width. Thus, only a closed layout change of a specified region in a page can be performed. Accordingly, the enhancement of readability of the character is limited and only a little effect can be obtained.

### SUMMARY OF THE INVENTION

The present invention is directed to enhancing document readability even if the document is generated to be used for an apparatus different from an apparatus which the user desires to use.

According to an aspect of the present invention, a display apparatus includes a designation unit configured to designate a number of pages, a calculation unit configured to calculate an enlargement ratio based on original data, the number of pages designated by the designation unit, and an area of a display unit, a size change unit configured to change a size of an object included in the original data based on the enlargement ratio calculated by the calculation unit, and a display unit configured to display the object whose size has been changed by the size change unit on the display unit on a page-by-page basis by using the number of pages designated by the designation unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of one page of original data displayed in four pages.

FIG. 2 illustrates an example of displaying original data of four pages in one page.

FIG. 3 illustrates an example of a hardware configuration of a PDA terminal as an example of a display apparatus.

FIG. 4 illustrates an example of a method for managing object information.

FIG. 5 illustrates an example of information stored in an object list.

FIG. 6 illustrates an example of reading a rectangular object similar to the object illustrated in FIG. 5 from a document in a PDF format and acquiring information of the object.

FIG. 7 illustrates a first basic operation.

FIG. 8 illustrates a calculating formula used for calculating a scaling ratio in the vertical and horizontal directions from an original data display area, an area of the display unit, and the number of divided pages.

FIG. 9 illustrates processing used for converting original data into data with no line breaking/wrapping.

FIG. 10 illustrates an example of processing which is performed when display of one page of original data in three pages is designated and the original data is displayed in more than three pages according to layout processing using the scaling ratio described with reference to FIG. 8.

FIG. 11 illustrates a second basic operation.

FIG. 12 illustrates a calculating formula used for calculating a scaling ratio in the vertical and horizontal directions from the original data display area, a display unit area, and the number of multiple-up pages.

FIG. 13 illustrates conversion processing of original data into data with no line breaking/wrapping.

FIG. 14, which is composed of FIGS. 14A and 14B, is a flowchart illustrating an example of page division and multiple-up processing when display processing is designated.

FIG. 15 is a flowchart illustrating page layout processing.

FIG. 16 illustrates calculating formulas used for obtaining reduction and enlargement ratios.

### DESCRIPTION OF THE EMBODIMENTS

Various exemplary embodiments, features, and aspects of the invention will be described in detail below with reference to the drawings.

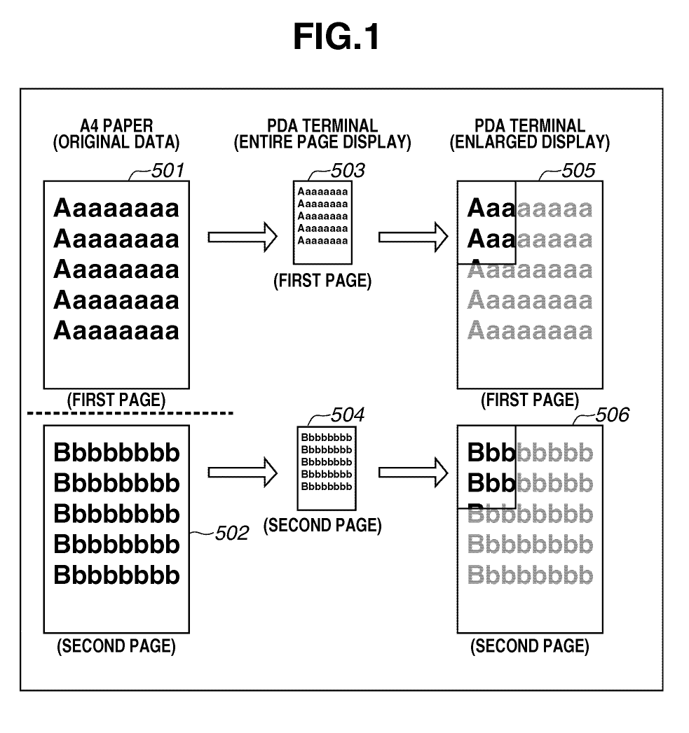

FIG. 1 illustrates an example of displaying one page of original data in four pages.

In FIG. 1, a first page 501 and a second page 502 of the original data, which is PDF data, are generated in the size of A4 paper. Conventionally, if the PDF data is displayed on a PDA by entire page display, since the display area of the PDA is small, the size of the characters which are displayed will be small. A first page 503 and a second page 504 displayed on the PDA terminal illustrate the PDF data in such a state. Accordingly, the data is hard to read. Thus, the user generally enlarges the page and reads the data by scrolling across and down the page. A first page 505 and a second page 505 displayed on the PDA terminal are the PDF data in such a state. According to the conventional technique illustrated in FIG. 1, the user needs to repeatedly scroll across and down to read the entire page. Such a user operation is cumbersome and complicated.

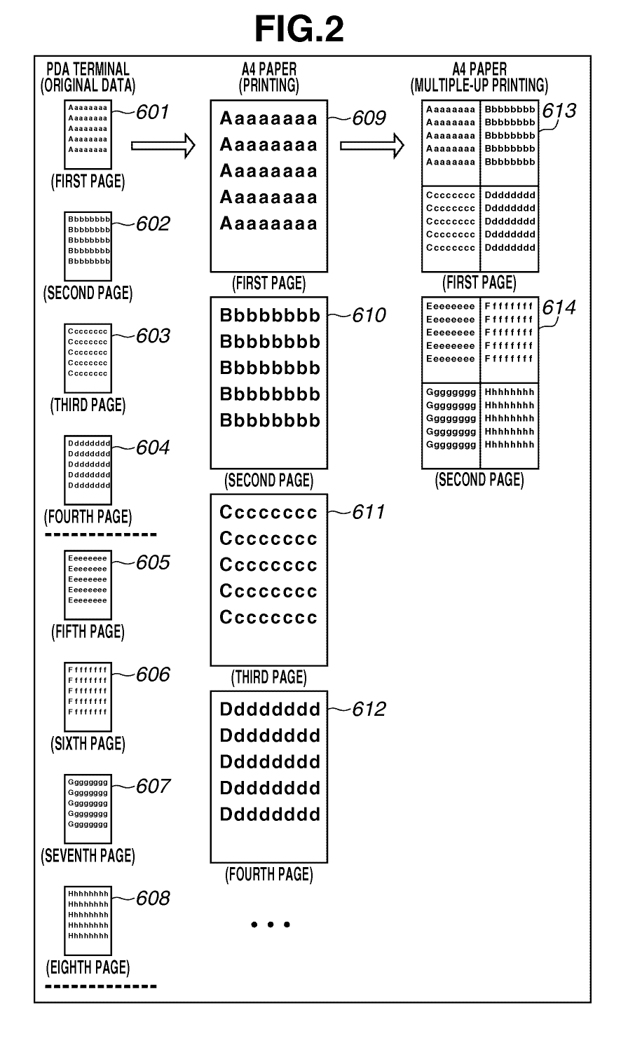

FIG. 2 illustrates an example of displaying original data of four pages in one page.

In FIG. 2, a first page 601 to an eighth page 608 of the original data, which is PDF data, are generated to fit the display size of a PDA. Conventionally, if this PDF data is printed on A4 paper, excessively large characters will be printed on the paper. A first page 609 to a fourth page 612 are the result of the printing on A4 paper. Thus, the user generally prints the data using multiple-up printing. A first page 613 and a second page 614 are the result of multiple-up printing. According to the conventional example illustrated in FIG. 2, not all numbers of pages can be designated for multiple-up printing. In other words, although the number of pages such as 2, 4, 6, 8, 9, and 16 can be designated for multiple-up printing, other numbers of pages cannot be designated for multiple-up printing. Further, if the number of pages 2 or 8 is designated, the arrangement of the pages will be different from that of the original data. Thus, the multiple-up printing is not appropriate for fixed display.

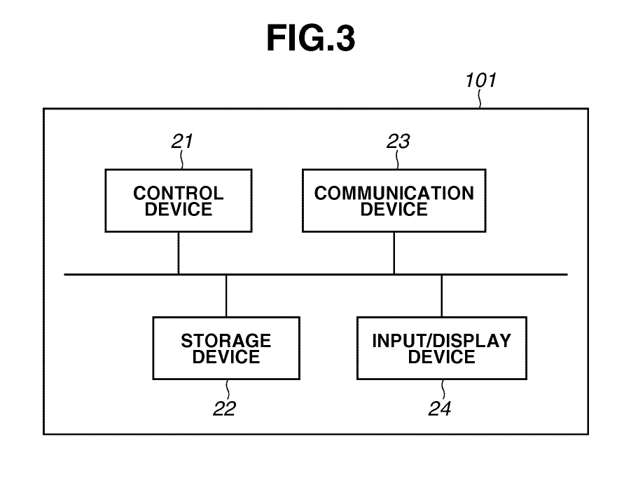

FIG. 3 illustrates an example of a hardware configuration of a PDA terminal 101 as an example of a display apparatus. As illustrated in FIG. 3, the PDA terminal 101 includes a control device 21, a storage device 22, a communication device 23, and an input/display device 24 as hardware configuration. The PDA terminal 101 is an example of a computer.

The control device 21 is, for example, a central processing unit (CPU) or the like and controls the entire PDA terminal 101. The storage device 22 is, for example, a read-only memory (ROM) or a random access memory (RAM). Programs as well as data which is used when the control device 21 controls the PDA terminal are stored in the storage device 22. The communication device 23 connects the PDA terminal 101 to a network. For example, the PDA terminal 101 is connected to a printer via the communication device 23. The input/display device 24 accepts information of the PDA terminal 101 input by the user and also displays images.

According to the present embodiment, although the PDA terminal 101 is described as an apparatus including the input/display device 24 that accepts input and displays images, an input device that accepts input and a display apparatus that displays images can be separately provided for the PDA terminal 101.

The control device 21 realizes the processing of the flowchart described below by executing processing based on a program stored in the storage device 22 or the like. Further, in the following description, the input/display device 24 is also referred to as a display unit.

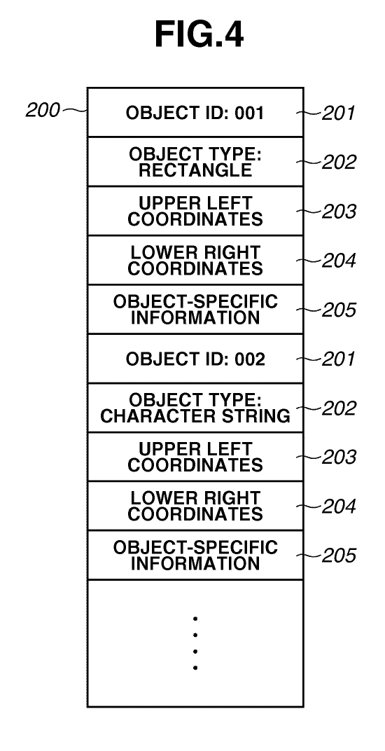

FIG. 4 illustrates an example of a method used for managing object information. Each object includes an ID 201, an object type 202, upper left coordinates 203 and lower right coordinates 204 which represent the position of the object, and object-specific information 205. The object information is set in a list structure and stored in an object list 200. If the object is a rectangular object, the object-specific information will be information of a line thickness and a line type of the rectangular object. If the object is a character string, the object-specific information will be information of a character typeface and a size of the character string. The object-specific information is stored for each object.

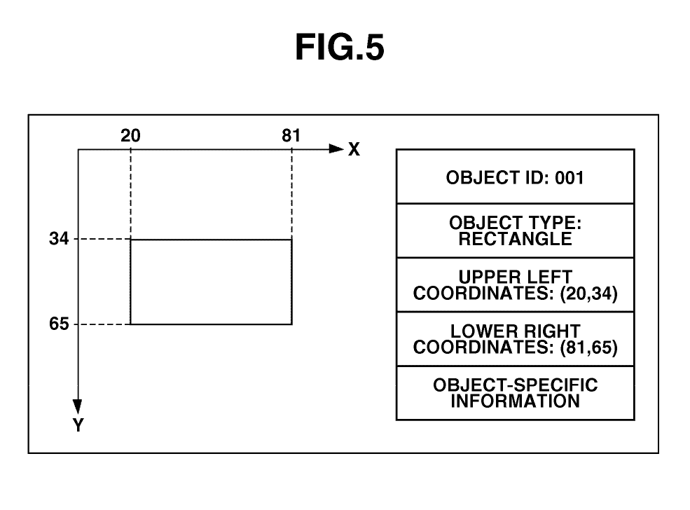

FIG. 5 illustrates an example of the object information stored in the object list 200. A rectangular object arranged at the coordinates in FIG. 5 is registered in a list as illustrated in FIG. 5.

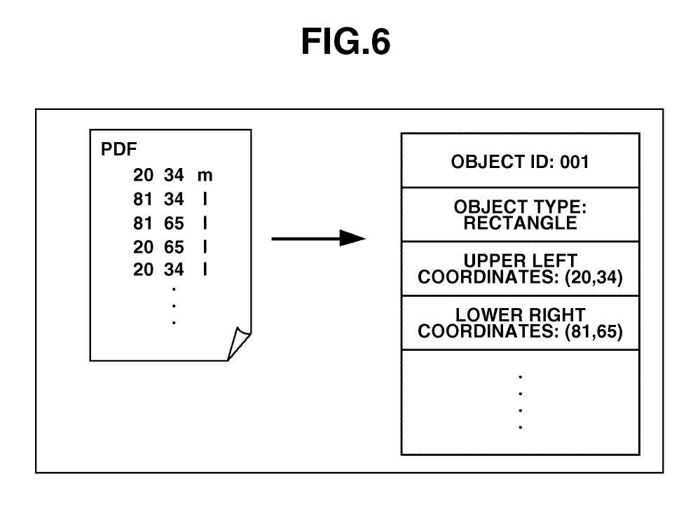

FIG. 6 illustrates an example of reading information of a rectangular object similar to the one illustrated in FIG. 5 from a document in PDF format and taking out the information as object information. In PDF format, a graphic expressed as connecting points of (20,34), (81,34), (81,65), (20,65), and (20,34) in this order is generated as a rectangular object with upper left coordinates (20,34) and lower right coordinates (81,65).

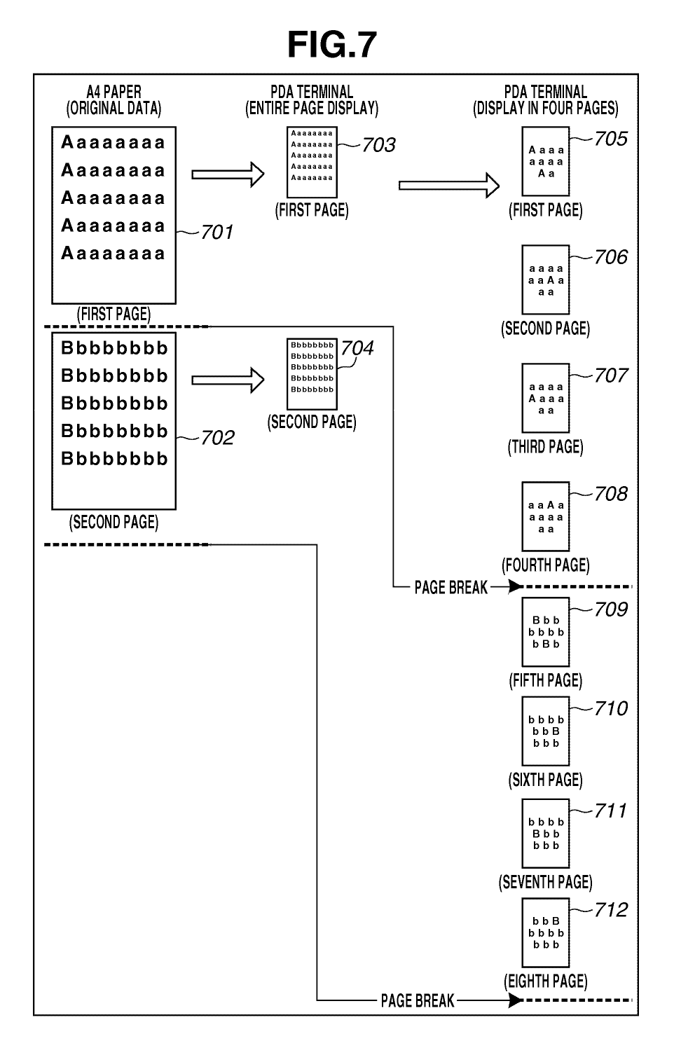

FIG. 7 illustrates a basic operation. FIG. 7 illustrates a case where one page of the original data is displayed in a plurality of pages. If a first page 701 and a second page 702 of the original data, which have been generated to fit A4 paper, are displayed on a PDA terminal, they are displayed as a first page 703 and a second page 704 and the size of the characters is very small. Thus, according to the present embodiment, the user designates the number of pages used for viewing one page of the original data on the PDA. Then, the one page of the original data is displayed on the PDA in the designated number of pages.

In FIG. 7, one page of the original data is displayed in four pages. To be more precise, the first page 701 is displayed in four pages (a first page 705 to a fourth page 708) and the second page of the original data 702 is also displayed in four pages (a first page 709 to a second page 712). By increasing the number of divided pages of the original data, characters of a larger size can be displayed. Thus, the user can increase the number of pages until the size of the characters is large enough for reading. Further, since the original data is divided into a plurality of pages in a unit of one page, data of different pages of the original data is not mixed in the page displayed by the PDA after the division. Accordingly, the characters at the top of each page of the original data are always arranged at the top of each page after the division.

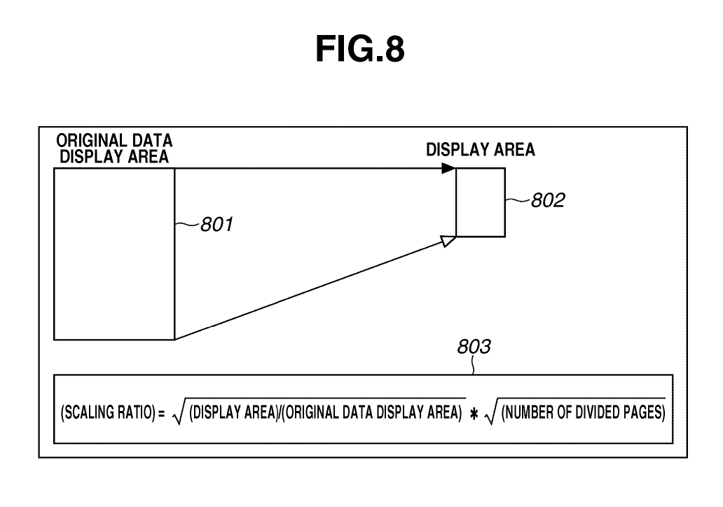

FIG. 8 illustrates a calculating formula used for calculating a scaling ratio in the vertical and horizontal directions from an original data display area, an area of the display unit, and the number of divided pages. A scaling ratio 803 can be obtained by multiplying the ratio of a display unit area 802 to an original data display area 801 by a square root of the number of divided pages.

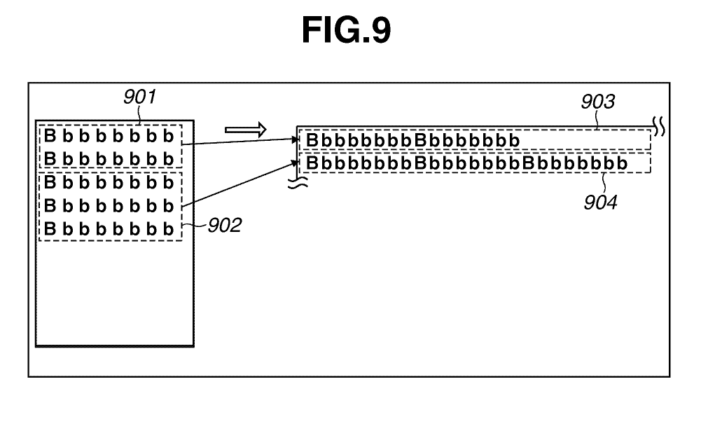

FIG. 9 illustrates conversion processing of the original data into data with no line breaking/wrapping. In FIG. 9, the original data is divided into texts 901 and 902. The text 901 is converted into non-breaking line data as illustrated in a text 903, and the text 902 is similarly converted into a text 904. Further, the Y coordinate position of the line is shifted according to the line above. Since the control device 21 considers that a new line is to be started and divides the original data if the line space is wide, the line is indented, or if there is a space corresponding to one character or more between the last character of the line and the right end of the line, the original data is divided into the texts 901 and 902.

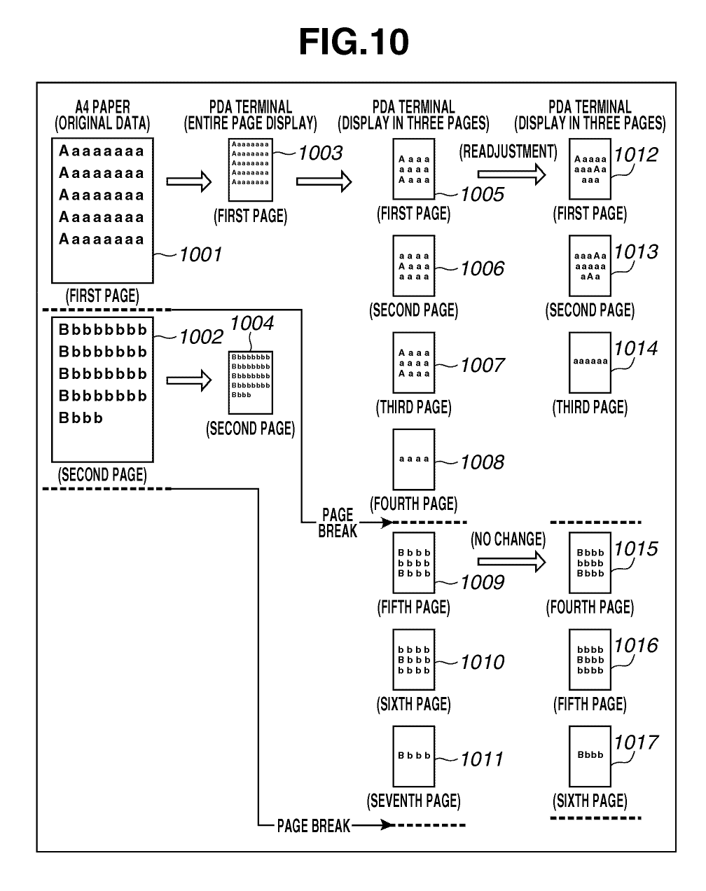

FIG. 10 illustrates a case where the user intends to display a first page 1001 and a second page 1002 of the original data in three pages. When the layout is performed using the scaling ratio described above in FIG. 8, the data does not fit in 3 pages. If the original data is composed of characters, the characters which do not fit in the right end or the bottom of the page are carried to the next line or the next page. Thus, the original data does not always fit in the designated number of pages according to the scaling ratio obtained by the formula in FIG. 8 and many blank lines may be included in a page.

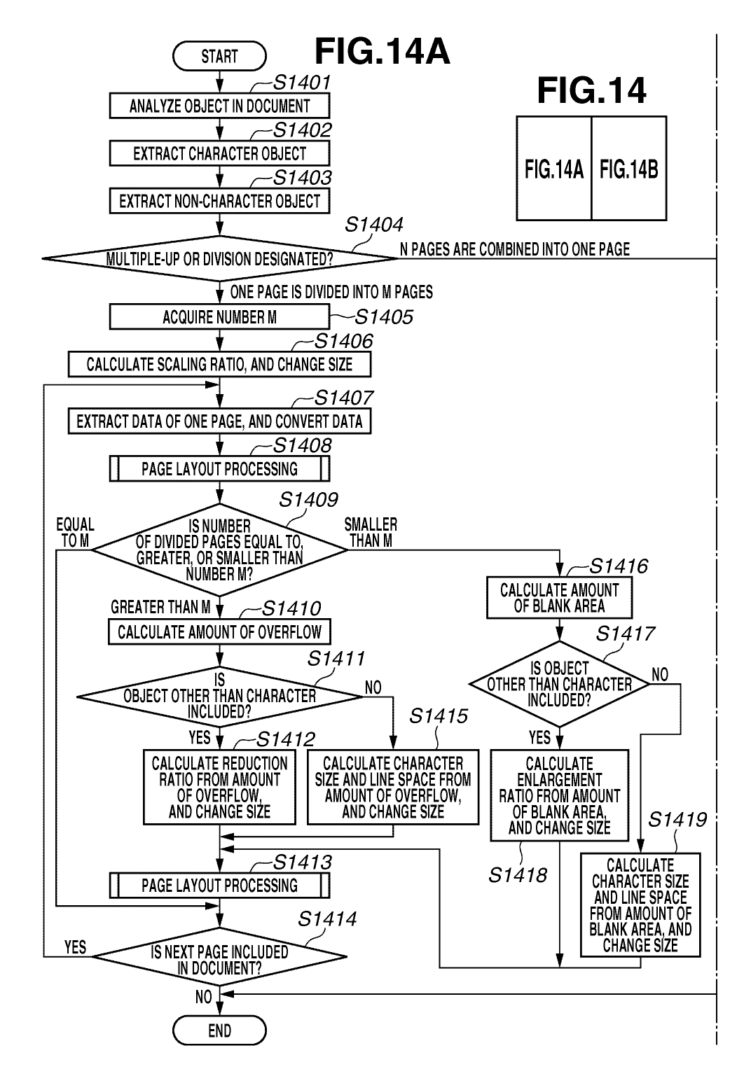

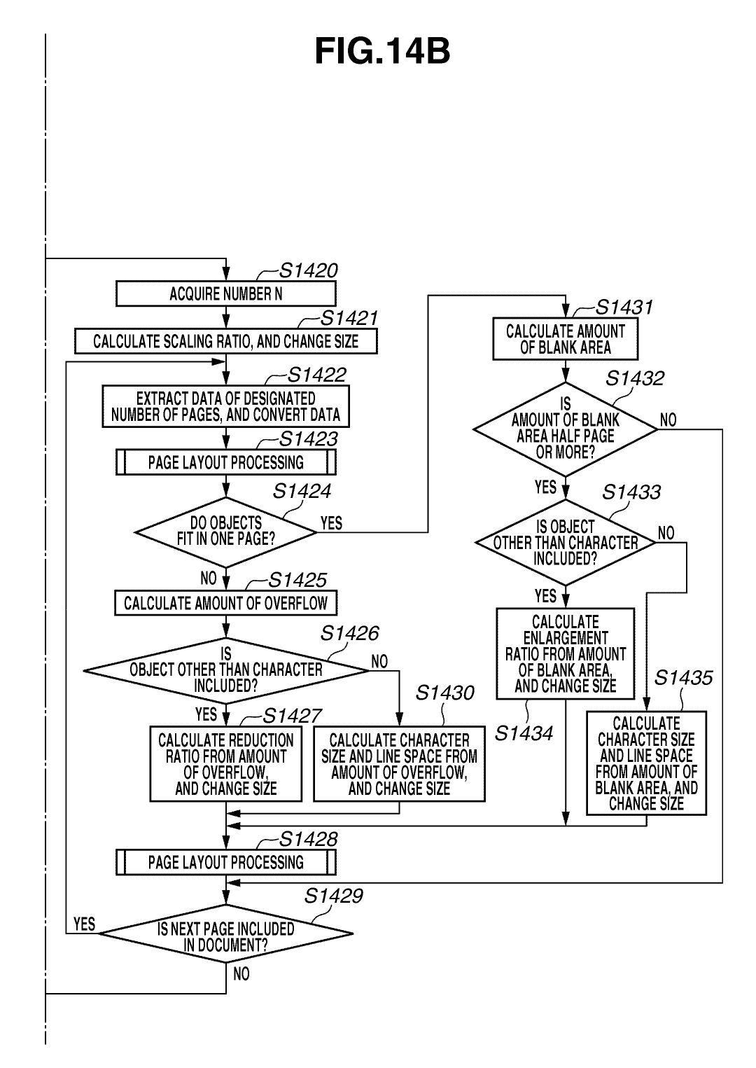

According to the example in FIG. 10, although the user intends to display the first page 1001 in three pages, the first page 1001 is actually displayed in four pages (a first page 1005 to a fourth page 1008). On the other hand, the second page 1002 of the original data is displayed in three pages (a fifth page 1009 to a seventh page 1011) as intended. Thus, readjustment is performed for the first page 1005 to the fourth page 1008 so that the first page 1001 is displayed in three pages (a first page 1012 to a third page 1014). Details of the re-layout processing when the number of pages exceeds the designated number of pages or too many blank lines are included in the designated number of pages will be described below with reference to FIG. 14.

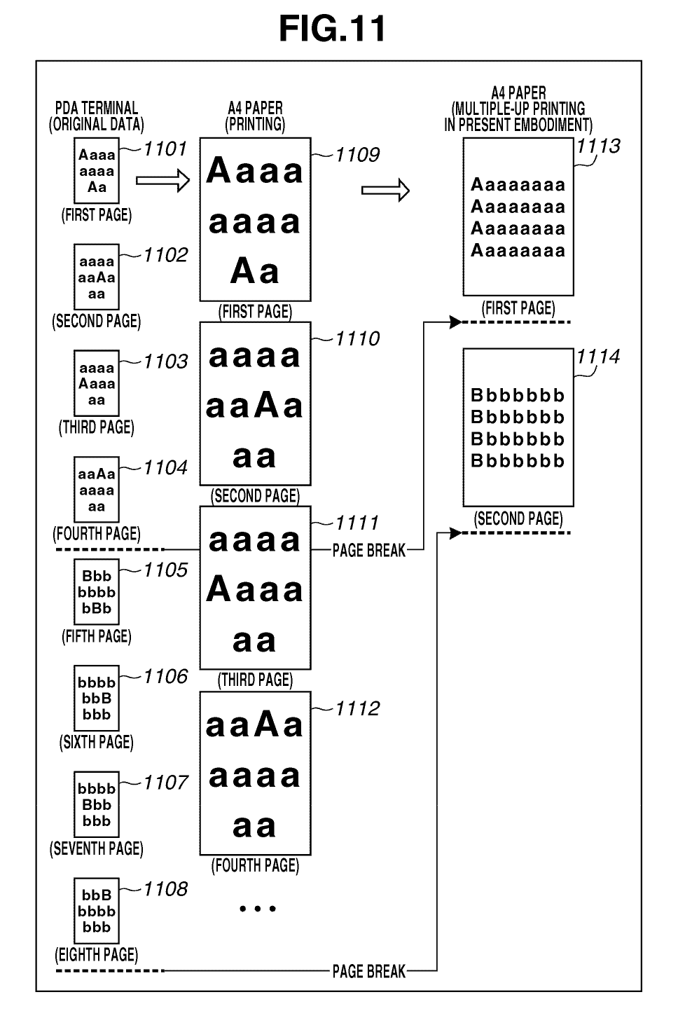

FIG. 11 illustrates another basic operation. Unlike the case illustrated in FIG. 7, a plurality of pages of the original data is displayed in one page. If a first page 1101 to a fourth page 1104 of the original data, which have been generated for display on a PDA, are printed on A4 paper (a first page 1109 to a fourth page 1112), excessively large characters will be printed and will be a waste of paper. According to the present embodiment, the user designates the number of pages of the original data to be displayed on one page of A4 paper. Then, multiple-up printing on A4 paper is performed according to the designated number of pages.

FIG. 11 illustrates an example of multiple-up printing of four pages. Four pages (the first page 1101 to the fourth page 1104) of the original data are displayed on one page (a first page 1113) and four pages (a fifth page 1105 to an eighth page 1108) of the original data are printed on one page (a second page 1114) by multiple-up printing. Although the use-efficiency of the paper can be improved by increasing the number of multiple-up pages, the character size becomes smaller. If the number of multiple-up pages is decreased, a larger character size can be obtained. Thus, the user can acquire a desired size by designating a desired number of multiple-up pages.

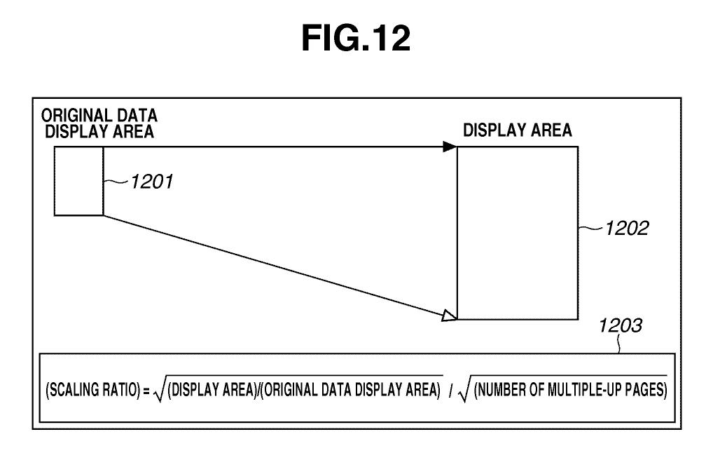

FIG. 12 illustrates a calculating formula used for calculating a scaling ratio in the vertical and horizontal directions from an original data display area, the area of a display unit, and the number of multiple-up pages. A scaling ratio 1203 can be obtained by dividing the ratio of a display unit area 1202 to an original data display area 1201 by a square root of the number of multiple-up pages.

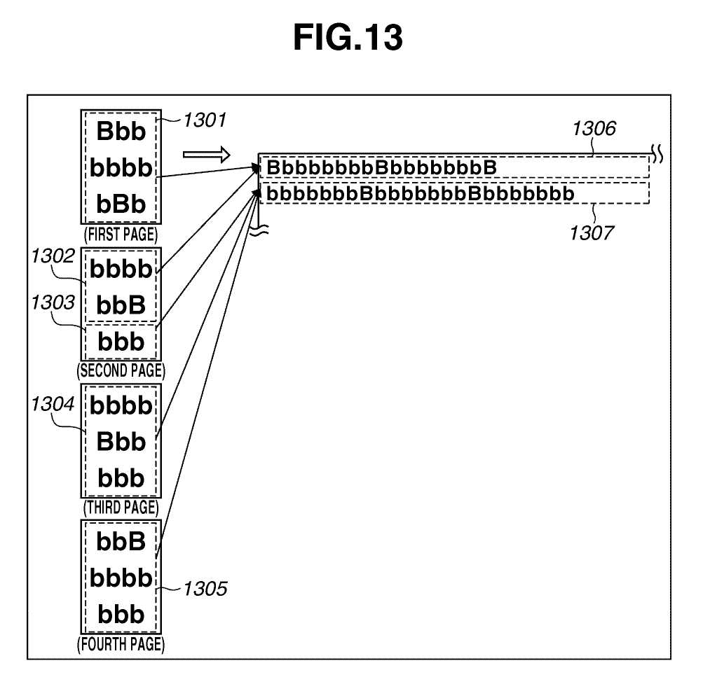

FIG. 13 illustrates conversion processing of the original data into data with no line breaking/wrapping. In FIG. 13, the original data is divided into texts 1301 and 1302 and texts 1303 to 1305. The texts 1301 and 1302 are converted into non-breaking line data as illustrated in a text 1306, and the texts 1303 to 1305 are similarly converted into non-breaking line data as illustrated in a text 1307. Further, the Y coordinate position of the line is shifted according to the line above. Since the control device 21 considers that a new line is to be started and divides the original data if the line space is wide, the line is indented, or if there is a space corresponding to one character or more between the last character of the line and the right end of the line, the original data is divided into two (the texts 1301 and 1302 and the texts 1303 to 1305).

FIG. 14, which is composed of FIGS. 14A and 14B, is a flowchart illustrating an example of the page division and the multiple-up processing when display of the original data is designated.

In step S1401, the control device 21 analyzes objects in a document as original data. In step S1402, the control device 21 extracts a character object (a text object). In step S1403, the control device 21 extracts a non-character object. The non-character object is an object other than a character (text) and is, for example, a graphic or an image.

In step S1404, the control device 21 determines whether multiple-up or division is designated. If one page is to be divided into a plurality of pages (“ONE PAGE IS DIVIDED INTO M PAGES” in step S1404), the processing proceeds to step S1405.

In step S1405, the control device 21 acquires a designated number M. The designated number M indicates the number of pages in which the original one page is displayed. In this case, one page is divided into M pages.

In step S1406, the control device 21 calculates a scaling ratio according to the above-described calculating formula 803 in FIG. 8, and changes the size of all the objects extracted in steps S1402 and S1403. The size change is performed by converting a coordinate's value and an attribute of the object size included in the object information described above with reference to FIG. 4 by the scaling ratio. The scaling ratio calculation processing in step S1406 is an example of first calculation processing. Further, the object size change processing in step S1406 is an example of first size conversion processing.

In step S1407, the control device 21 extracts the object of the next one page. When the control device 21 extracts the object, the control device 21 also performs the data conversion described above with reference to FIG. 9. The data conversion processing in step S1407 is an example of first conversion processing.

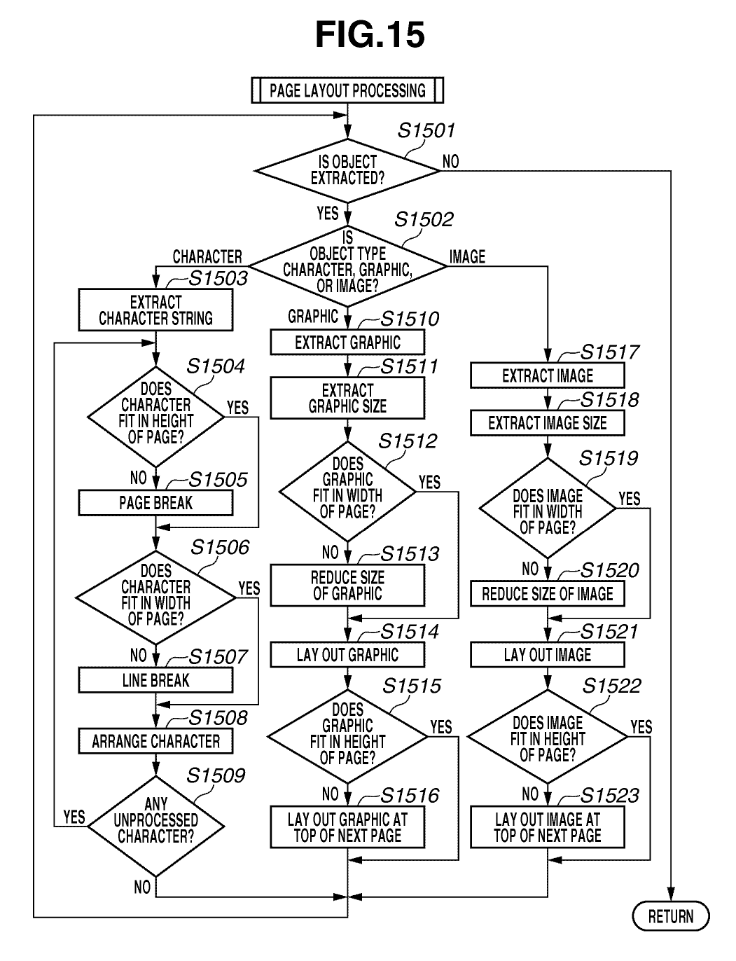

In step S1408, the control device 21 performs in-page object layout processing described below with reference to FIG. 15. The in-page object layout processing in step S1408 is an example of first layout processing.

In step S1409, the control device 21 determines whether the number of divided pages is equal to, greater than, or smaller than the designated number M. If the number of divided pages is equal to the designated number M (“EQUAL TO M” in step S1409), the processing proceeds to step S1414. If the number of divided pages is greater than the designated number M (“GREATER THAN M” in step S1409), the processing proceeds to step S1410.

In step S1410, the control device 21 calculates the amount of overflow. The control device 21 obtains the amount of overflow according to a maximum Y coordinate position of the object, which has been arranged on the next page, from the top of that page.

In step S1411, the control device 21 determines whether a non-character object is included in the page extracted in step S1407. If a non-character object is included (YES in step S1411), the processing proceeds to step S1412.

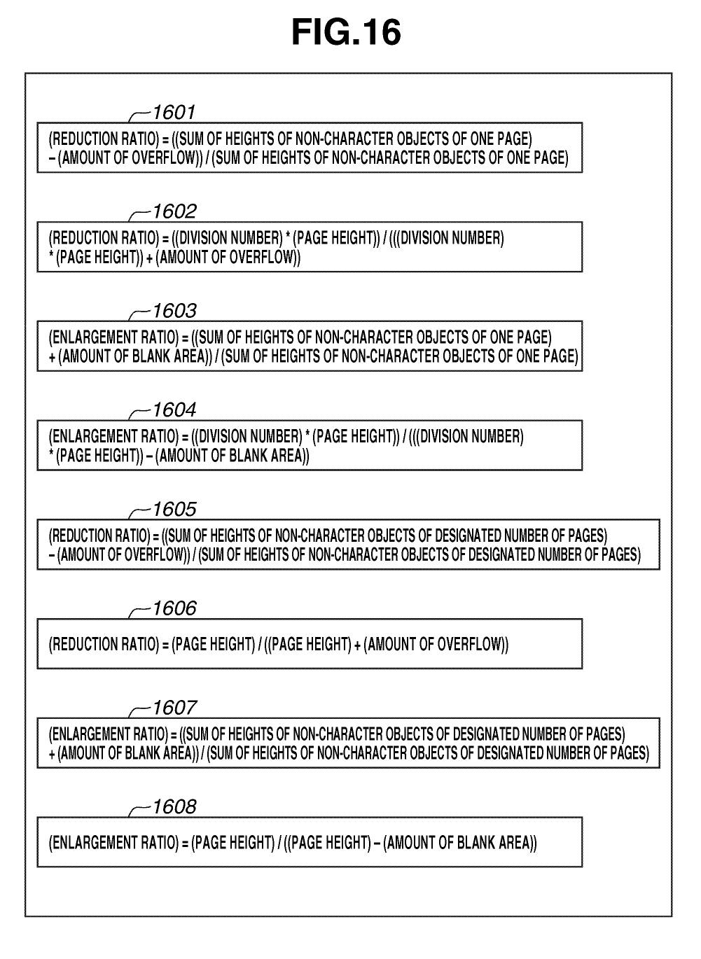

In step S1412, the control device 21 calculates a reduction ratio of the non-character object from the amount of overflow and changes the size of the object. The control device 21 calculates the reduction ratio by using a calculating formula 1601 in FIG. 16 described below. In step S1413, the control device 21 performs the in-page object layout processing.

In step S1414, the control device 21 determines whether the next page exists. If the next page exists (YES in step S1414), the processing returns to step S1407. If the next page does not exist (NO in step S1414), the processing ends.

On the other hand, according to the determination in step S1411, if a non-character object is not included (NO in step S1411), the processing proceeds to step S1415. In step S1415, the control device 21 calculates a character size and a line space from the amount of overflow and changes the size of the object. The control device 21 obtains the reduction ratio by using a calculating formula 1602 in FIG. 16 described below. Then, the control device calculates a character size and line space after the correction using the reduction ratio and changes the size of the object.

Further, according to the determination in step S1409, if the number of divided pages is smaller than the designated number M (“SMALLER THAN M” in step S1409), the processing proceeds to step S1416. For example, if a small amount of data is to be displayed, the data may fit in a number of pages smaller than the designated number of divided pages. For example, if a page that contains characters and graphics only in the upper half (i.e., the lower half is blank) is divided into four pages, the characters and graphics can be displayed in two pages (i.e., the rest of the pages (two pages) will be blank).

In step S1416, the control device 21 obtains an amount of blank area by multiplying a page height by the number of blank pages.

In step S1417, the control device 21 determines whether a non-character object is included in the page extracted in step S1407. If a non-character object is included (YES in step S1417), the processing proceeds to step S1418.

In step S1418, the control device 21 calculates an enlargement ratio of the non-character object using the amount of blank area and changes the size of the object. Then, the processing proceeds to step S1413. The control device 21 calculates the enlargement ratio by using a calculating formula 1603 described below with reference to FIG. 16.

On the other hand, according to the determination in step S1417, if a non-character object is not included (NO in step S1417), the processing proceeds to step S1419. In step S1419, the control device 21 calculates a character size and a line space from the amount of blank area and changes the size of the object. Then, the processing proceeds to step S1413. The control device 21 obtains the enlargement ratio by using a calculating formula 1604 in FIG. 16 described below. Then, the control device 21 calculates a character size and a line space after the correction using the enlargement ratio and changes the size of the object.

Further, according to the determination in step S1404, if a plurality of pages is to be combined into one page (“N PAGES ARE COMBINED INTO ONE PAGE” in step S1404), the processing proceeds to step S1420. In step S1420, the control device 21 acquires a designated number N. The designated number N indicates the number of pages which are combined into one page. In this case, N pages are combined into one page.

In step S1421, the control device 21 calculates a scaling ratio according to the above-described calculating formula 1203 in FIG. 12, and changes the size of all the objects extracted in steps S1402 and S1403. The control device 21 performs the size change by converting a coordinates value and an attribute of the object size included in the object information described above with reference to FIG. 4 by the scaling ratio. The scaling ratio calculation processing in step S1421 is an example of second calculation processing. Further, the object size change processing in step S1406 is an example of second size conversion processing.

In step S1422, the control device 21 extracts the object of the next designated page. When the control device 21 extracts the object, the control device 21 also performs the data conversion described above with reference to FIG. 13. The data conversion processing in step S1422 is an example of second conversion processing.

In step S1423, the control device 21 performs in-page object layout processing described below with reference to FIG. 15. The object layout processing in step S1423 is an example of second layout processing.

In step S1424, the control device 21 determines whether the objects fit in one page after they are combined. If the objects do not fit in one page (NO in step S1424), the processing proceeds to step S1425. In step S1425, the control device 21 calculates the amount of overflow. The control device 21 obtains the amount of overflow according to a maximum Y coordinate position of the object which has been arranged on the next page.

In step S1426, the control device 21 determines whether a non-character object is included in the page extracted in step S1422. If a non-character object is included (YES in step S1426), the processing proceeds to step S1427.

In step S1427, the control device 21 calculates a reduction ratio of the non-character object from the amount of overflow and changes the size of the object. The control device 21 calculates the reduction ratio by using a calculating formula 1605 in FIG. 16 described below. In step S1428, the control device 21 performs the in-page object layout processing.

In step S1429, the control device 21 determines whether a next page exists. If a next page exists (YES in step S1429), the processing returns to step S1422. If a next page does not exist (NO in step S1429), the processing ends.

On the other hand, according to the determination in step S1426, if a non-character object is not included (NO in step S1426), the processing proceeds to step S1430. In step S1430, the control device 21 calculates a character size and a line space from the amount of overflow, and changes the size of the object. The control device 21 obtains the reduction ratio by using a calculating formula 1606 in FIG. 16 described below. Then, the control device calculates a character size and a line space after the correction using the reduction ratio and changes the size of the object.

Further, according to the determination in step S1424, if the objects fit in one page (YES in step S1424), the processing proceeds to step S1431. In step S1431, the control device 21 calculates the amount of blank area. The control device 21 calculates the amount of blank area by subtracting the maximum Y coordinate position of the object arranged on the page from the page height.

In step S1432, the control device 21 determines whether the amount of blank area is half page or more. If the amount of blank area is less than half page (NO in step S1432), the processing proceeds to step S1429.

On the other hand, if the amount of blank area is half page or more (YES in step S1432), the processing proceeds to step S1433. In step S1433, the control device 21 determines whether a non-character object is included in the page extracted in step S1422. If a non-character object is included (YES in step S1433), the processing proceeds to step S1434.

In step S1434, the control device 21 calculates an enlargement ratio of the non-character object using the amount of blank area and changes the size of the object. Then, the processing proceeds to step S1428. The control device 21 calculates the enlargement ratio by using a calculating formula 1607 described below with reference to FIG. 16.

On the other hand, according to the determination in step S1433, if a non-character object is not included (NO in step S1433), the processing proceeds to step S1435. In step S1435, the control device 21 calculates a character size and a line space from the amount of blank area and changes the size of the object. Then, the processing proceeds to step S1428. The control device 21 obtains the enlargement ratio by using a calculating formula 1608 in FIG. 16 described below. Then, the control device calculates a character size and aline space after the correction using the enlargement ratio and changes the size of the object.

FIG. 15 is a flowchart illustrating procedures of the page layout processing.

In step S1501, the control device 21 determines whether an object is extracted. If an object is not extracted (NO in step S1501), the processing returns to the processing in FIG. 14. If an object is extracted (YES in step S1501), the processing proceeds to step S1502.

In step S1502, the control device 21 determines whether the object type is “character”, “graphic”, or “image”. If the object type is “character” (“CHARACTER” in step S1502), the processing proceeds to step S1503. In step S1503, the control device 21 extracts a character string.

In step S1504, the control device 21 determines whether a character in the character string fits in the height of the page by taking one character from the character string and comparing it with character height information and Y coordinate position information of the character. If the character fits in the height of the page (YES in step S1504), the processing proceeds to step S1506. If the character does not fit in the height of the page (NO in step S1504), the processing proceeds to step S1505.

In step S1505, the control device 21 performs page break processing and moves the Y coordinate position to the top of the new page.

In step S1506, the control device 21 determines whether the character fits in the width of the page. If the character fits in the width of the page (YES in step S1506), the processing proceeds to step S1508. If the character does not fit in the width of the page (NO in step S1506), the processing proceeds to step S1507.

In step S1507, the control device 21 performs line break processing. The control device 21 moves the X coordinate position to the left end of the page and further moves the Y coordinate position toward the bottom of the page. The length of movement corresponds to the height of the character and the line space.

In step S1508, the control device 21 performs the layout of the character and moves the character to the right corresponding to the width of the character.

In step S1509, the control device 21 determines whether any unprocessed character is included. If any unprocessed character is not included (NO in step S1509), the processing returns to step S1501. If an unprocessed character is included (YES in step S1509), the processing returns to step S1504.

On the other hand, according to the determination in step S1502, if the object type is “graphic” (“GRAPHIC” in step S1502), the processing proceeds to step S1510.

In step S1510, the control device 21 extracts a graphic.

In step S1511, the control device 21 extracts a size of the graphic. The control device 21 extracts the size of the graphic by calculating a circumscribed rectangle of the graphic.

In step S1512, the control device 21 determines whether the width of the graphic fits in the width of the page. If the width of the graphic fits in the width of the page (YES in step S1512), the processing proceeds to step S1514. If the width of the graphic does not fit in the width of the page (NO in step S1512), the processing proceeds to step S1513.

In step S1513, the control device 21 reduces the size of the graphic so that the width of the graphic fits in the page.

In step S1514, the control device 21 performs layout processing of the graphic.

In step S1515, the control device 21 determines whether the graphic fits in the height of the page. If the graphic fits in the height of the page (YES in step S1515), the processing returns to step S1501. If the graphic does not fit in the height of the page (NO in step S1515), the processing proceeds to step S1516.

In step S1516, the control device 21 performs the page break processing and arranges the graphic at the top of the next page. Then, the processing returns to step S1501.

On the other hand, according to the determination in step S1502, if the object type is “image” (“IMAGE” in step S1502), the processing proceeds to step S1517. In step S1517, the control device 21 extracts an image.

In step S1518, the control device 21 extracts a size of the image. The control device 21 extracts the size of the image by calculating a circumscribed rectangle of the image. In step S1519, the control device 21 determines whether the width of the image fits in the width of the page. If the width of the image fits in the width of the page (YES in step S1519), the processing proceeds to step S1521. If the width of the image does not fit in the width of the page (NO in step S1519), the processing proceeds to step S1520. In step S1520, the control device 21 reduces the size of the image so that the image fits in the width of the page.

In step S1521, the control device 21 performs layout processing of the image.

In step S1522, the control device 21 determines whether the image fits in the height of the page. If the image fits in the height of the page (YES in step S1522), the processing returns to step S1501. If the image does not fit in the height of the page (NO in step S1522), the processing proceeds to step S1523. In step S1523, the control device 21 performs the page break processing and arranges the image at the top of the next page. Then, the processing returns to step S1501.

FIG. 16 illustrates calculating formulas used for obtaining the reduction ratio and the enlargement ratio according to the present embodiment.

The calculating formula 1601 is used for obtaining the reduction ratio in step S1412 in FIG. 14.

In the calculating formula 1601, “sum of heights of non-character objects of one page” is a sum of heights of graphic and image objects. These objects are extracted from data of one page extracted by the control device 21 in step S1407. The data of one page is obtained after the size of the objects is changed in step S1406.

Further, “amount of overflow” is an amount that exceeds when the number of divided pages is greater than the designated number of pages M. The control device 21 obtains the “amount of overflow” by calculating the maximum Y coordinate position from the top of the page of the object arranged on the page that exceeded. Thus, the control device 21 obtains the “reduction ratio” from the calculating formula 1601 by using the “sum of heights of non-character objects of one page” and the “amount of overflow”.

The calculating formula 1602 is used for obtaining the reduction ratio in step S1415 in FIG. 14.

In the calculating formula 1602, “division number” is the designated number of pages M and “page height” is the height of the display unit. Further, “amount of overflow” is an amount that exceeds when the number of divided pages is greater than the designated number of pages M. The control device 21 obtains the “amount of overflow” by calculating the maximum Y coordinate position from the top of the page of the object arranged on the page that exceeded. Thus, the control device 21 obtains the “reduction ratio” from the calculating formula 1602 by using the “division number”, the “page height” and the “amount of overflow”.

The calculating formula 1603 is used for obtaining the enlargement ratio in step S1418 in FIG. 14.

In the calculating formula 1603, “sum of heights of non-character objects of one page” is a sum of heights of graphic and image objects. These objects are extracted from data of one page extracted by the control device 21 in step S1407. The data of one page is obtained after the size of the objects is changed in step S1406.

Further, “amount of blank area” is obtained by the control device 21 multiplying the page height by the number of blank pages. Thus, the control device 21 obtains the “enlargement ratio” from the calculating formula 1603 by using the “sum of heights of non-character objects of one page” and the “amount of blank area”.

The calculating formula 1604 is used for obtaining the enlargement ratio in step S1419 in FIG. 14.

In the calculating formula 1604, “division number” is the designated number of pages M and “page height” is the height of the display unit. Further, “amount of blank area” is obtained by the control device 21 multiplying the page height by the number of blank pages. Thus, the control device 21 obtains the “enlargement ratio” from the calculating formula 1604 by using the “division number”, “the page height”, and the “amount of blank area”.

The calculating formula 1605 is used for obtaining the reduction ratio in step S1427 in FIG. 14.

In the calculating formula 1605, “sum of heights of non-character objects of designated number of pages” is a sum of heights of graphic and image objects. These objects are extracted from data of the designated number of pages extracted by the control device 21 in step S1422. The data of the designated number of pages is obtained after the size of the objects is changed in step S1421. Further, “amount of overflow” is an amount that exceeds one page when the combined pages do not fit in one page. The “amount of overflow” is obtained by the control device 21 calculating the maximum Y coordinate position of the object arranged on top of the next page. Thus, the control device 21 obtains the “reduction ratio” from the calculating formula 1605 by using the “sum of heights of non-character objects of designated number of pages” and the “amount of overflow”.

The calculating formula 1606 is used for obtaining the reduction ratio in step S1430 in FIG. 14.

In the calculating formula 1606, “page height” is the height of the display unit. Further, “amount of overflow” is an amount that exceeds one page when the combined pages do not fit in one page. The “amount of overflow” is obtained by the control device 21 calculating the maximum Y coordinate position of the object arranged on top of the next page. Thus, the control device 21 obtains the “reduction ratio” from the calculating formula 1606 by using the “page height” and the “amount of overflow”.

The calculating formula 1607 is used for obtaining the enlargement ratio in step S1434 in FIG. 14.

In the calculating formula 1607, “sum of heights of non-character objects of designated number of pages” is a sum of heights of graphic and image objects. These objects are extracted from data of the designated number of pages extracted by the control device 21 in step S1422. The data of the designated number of pages is obtained after the size of the objects is changed in step S1421. Further, “amount of blank area” is obtained by the control device 21 subtracting the maximum Y coordinate position of the object arranged on the page from the page height. Thus, the control device 21 obtains the “enlargement ratio” from the calculating formula 1607 by using the “sum of heights of non-character objects of designated number of pages” and the “amount of blank area”.

The calculating formula 1608 is used for obtaining the enlargement ratio in step S1435 in FIG. 14.

In the calculating formula 1608, “page height” is the height of the display unit. Further, “amount of blank area” is obtained by the control device 21 subtracting the maximum Y coordinate position of the object arranged on the page from the page height. Thus, the control device 21 obtains the “enlargement ratio” from the calculating formula 1607 by using the “page height” and the “amount of blank area”.

As described above, by providing a scaling display mechanism to the PDA terminal 101, even if a document is a document generated for display on an apparatus different from an apparatus the user desires to use, the document can be scaled up/down to an easy-to-read size. In other words, the document can always be scaled up/down to an easy-to-read size and displayed in a size that fits in the width of the display unit whenever it is displayed.

Accordingly, when the user performs the enlargement display, scrolling in the lateral direction is unnecessary. Further, since the height of one page in the longitudinal direction fits in the height of the display terminal, the entire document can be viewed by simply flipping pages. Further, since one page of the original data is divided into a plurality of pages, the top of each page of the original data is always displayed at the top of the page of the display apparatus. Since the page of the display apparatus is not started with the middle of the page of the original data, even if the user desires to read a document from a specified page, the user can easily start reading with that page.

Further, with respect to the reduction display, when a plurality of pages is combined into one page, an arbitrary number of pages can be designated. Further, since the page orientation is not changed, the present embodiment can be used for display on a fixed display terminal.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-132496 filed Jun. 14, 2011, which is hereby incorporated by reference herein in its entirety.

What is claimed is:

1. A display apparatus comprising:
a designation unit configured to designate a number of pages;
a calculation unit configured to calculate an enlargement ratio based on original data, the number of pages designated by the designation unit, and an area of a display unit;
a size change unit configured to change a size of an object included in the original data based on the enlargement ratio calculated by the calculation unit; and
a display unit configured to display the object whose size has been changed by the size change unit on the display unit on a page-by-page basis by using the number of pages designated by the designation unit.

2. The display apparatus according to claim 1, wherein the display unit displays a character string object in such a manner that line wrapping of the character string object occurs at an end of the display unit.

3. The display apparatus according to claim 1, further comprising an enlargement unit configured to enlarge an object other than a character or enlarge a line space of a character object such that the object can be arranged without a blank area in the number of pages designated by the designation unit.

4. The display apparatus according to claim 1, further comprising:
a data conversion unit configured to convert the object whose size has been changed by the size change unit into data without limitation of page width and length; and
a layout unit configured to lay out the object converted by the data conversion unit on the display unit on a page-by-page basis.

5. A display method comprising:
designating a number of pages;
calculating an enlargement ratio based on original data, the designated number of pages, and an area of a display unit;
changing a size of an object included in the original data based on the calculated enlargement ratio; and
displaying the object whose size has been changed on the display unit on a page-by-page basis by using the designated number of pages.

6. The display method according to claim 5, further comprising displaying a character string object in such a manner that line wrapping of the character string occurs at an end of the display unit.

7. The display method according to claim 5, further comprising enlarging an object other than a character or enlarging a line space of a character object such that the object can be arranged without a blank area in the designated number of pages.

8. The display method according to claim 5, further comprising:
converting the object whose size has been changed into data without limitation of page width and length; and
performing layout of the converted object on the display unit on a page-by-page basis.

9. A non-transitory computer-readable storage medium storing a program that causes a computer to perform a method comprising:
designating a number of pages;
calculating an enlargement ratio based on original data, the designated number of pages, and an area of a display unit;
changing a size of an object included in the original data based on the calculated enlargement ratio; and
displaying the object whose size has been changed on the display unit on a page-by-page basis by using the designated number of pages.
